(19) United States
(12) Patent Application Publication
(10) Pub. No.: US 2013/0044133 A1
(43) Pub. Date: Feb. 21, 2013

(54) DETERMINATION OF BLANK SECTORS IN DIGITAL IMAGES

(71) Applicant: Diego Dayan, Buenos Aires (AR)

(72) Inventor: Diego Dayan, Buenos Aires (AR)

(21) Appl. No.: 13/661,173

(22) Filed: Oct. 26, 2012

Related U.S. Application Data
(63) Continuation of application No. PCT/IB2011/051623, filed on Apr. 14, 2011.

(30) Foreign Application Priority Data
Apr. 14, 2010 (GB) 1006139.8

(51) Int. Cl. G09G 5/377

(52) U.S. Cl. 345/641

(57) ABSTRACT

A process for producing rectangular aggregates in a digital image in which a user is directed to put annotation relating to the image. The process includes implementing a divergence level calculation procedure for categorizing the pixels of the image either above or below a divergence threshold. Then, imposing a grid on the image, of which each grid element is larger than a pixel. Further, implementing a grid element homogeneity calculation procedure, by employing homogeneity threshold for classifying the grid elements as being either homogeneous or non-homogeneous. Further, implementing a rectangular aggregate formation procedure, in which homogeneous grid elements are grouped in rectangles.

### CROSS REFERENCE TO RELATED APPLICATIONS

This application claims priority from patent application GB 1006139.8, entitled “DETERMINATION OF BLANK SECTORS IN DIGITAL IMAGES”, filed on Apr. 14, 2010; and is a national stage entry of international application PCT/IB2011/051,623, entitled “DETERMINATION OF BLANK SECTORS IN DIGITAL IMAGES” and filed on Apr. 14, 2011, the entire contents of which are incorporated herein by reference.

### FIELD OF THE INVENTION

The present invention relates to a method of finding within Images sectors having reduced features content.

### BACKGROUND OF THE INVENTION

Digital images have become a commodity. Photo albums, archives of almost any kind, electronic media, the Internet and cellular networks use digital images for storage, archiving, transmission and further processing. The present invention is about an automatic or automated method for finding a sector within an image in which annotation/s can be inserted at minimal obstruction caused to the intelligibility of the combination of features portrayed in the image. Digital images are composed of an x and y array of pixels, each pixel (also known as picture element) contains a level of variability in color or gray it has obtained from the camera or scanner, out of the possible range that the imaging hardware can support. For color images, each pixel has references to a specific level for each of the three color components of the standard of color employed by the imaging device producing the image.

### SUMMARY OF THE INVENTION

A process for producing rectangular aggregates in a digital image in which a user is directed to put annotation relating to the image. The process includes implementing a divergence level calculation procedure for categorizing the pixels of the image either above or below a divergence threshold. Then, imposing a grid on the image, of which each grid element is larger than a pixel. Further, implementing a grid element homogeneity calculation procedure, by employing homogeneity threshold for classifying the grid elements as being either homogeneous or non-homogeneous. Further, implementing a rectangular aggregate formation procedure, in which homogeneous grid elements are grouped in rectangles.

Other features and advantages of the instant invention will become apparent from the following description of the invention which refers to the accompanying drawings.

### BRIEF DESCRIPTION OF THE DRAWINGS

FIG. 1 is a flow chart showing the flow of the process of the invention in which divergence of pixels is the base of categorization of sectors;

FIG. 2 is a schematic of the relative positioning of pixels and reference pixels in an embodiment of the invention for providing divergence level values;

FIG. 3A is a schematic of pixels of a real image;

FIG. 3B is a schematic of pixels of a synthetic image expressing divergence level values;

FIG. 3C is a schematic of positive pixel distribution map in an image post divergence categorization;

FIG. 3D is a scheme of the grid of grid elements;

FIG. 3E is a scheme of the grid of grid elements superimposed on the positive pixel distribution map;

FIG. 3F is a schematic of grid elements having surpassed the non-homogeneity threshold;

FIG. 3G is a schematic of a grid elements map showing both types of grid elements marked;

FIG. 3H is a schematic of grid elements map showing those grid elements of lesser homogeneity count demarcated;

FIG. 4A is a schematic of a grid element map showing an exemplary distribution of marked grid elements;

FIG. 4B is a schematic of grid elements map showing an exemplary distribution of marked grid elements and first randomly selected grid element which happens to be a non-blank grid element;

FIG. 4C is a schematic of grid elements map showing an exemplary distribution of marked grid elements and a randomly selected blank grid element;

FIGS. 5A-5H are schematics of grid elements maps showing further principles of an exemplary rectangular aggregate formation procedure;

FIG. 6 is a flow chart of the flow of the process of the invention in which three tracks may be invoked at once; and

FIG. 7 is a flow chart of the flow of the process of the invention in which three tracks may be alternatively invoked.

### DETAILED DESCRIPTION OF THE INVENTION

In accordance with the present invention, a digital image is processed in several stages in order to finally demarcate sectors within the image that are suggested to the user as best choice for inserting annotation within the image. Such sectors will be referred to as being blank, a term to be used throughout this document to refer to the willfully computed groups of pixels indicating the seclusion from the rest of the image, in which the user is permitted or guided to insert own pictorial or textual items.

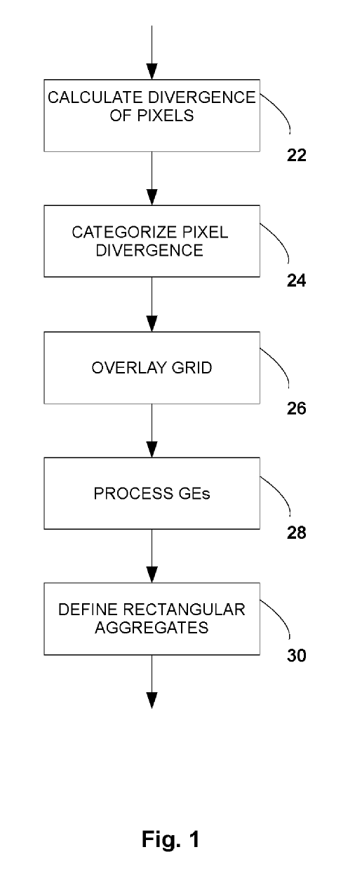

FIG. 1 shows a flow chart of a general, partial implementation of the invention, focusing on calculation steps. Before subjecting the image to the process of the invention, it may be overviewed to find any irregularities or special features which may affect the results of the process. In step 22 each pixels of the image is referred to a respective reference pixel and the divergence between the two is calculated. In step 24 each of the pixels in the image is categorized into either one of two categories, pixels exhibiting high divergence and such pixels exhibiting low divergence (with respect to a respective reference pixel). This categorization procedure will be explained in more details later on. Next, in step 26, a virtual grid is overlaid on the image, and in step 28 each grid element (GE) is processed individually as will be explained later on. In step 30, rectangular areas are defined.

The user who wishes to add annotations to an image subjects the image to the process of the invention, and as a result of which he/she are presented with a graphical demarcation of the rectangles available for adding annotations onto that image, to be further performed by for example dragging and dropping a graphical object into a selected rectangle on the image. In another aspect, the image sent over to a user may be subjected to the process of the invention a priori, so that the image, sent for example over the Internet may be annotated it without invoking the process of the invention at the receiving end. The user, after annotating may resend the annotated image to another user by way of the communications channel for personal or commercial use.

More technical description of critical procedures within the general process will be dealt with in some detail following.

Pixel Divergence and Categorization Procedure

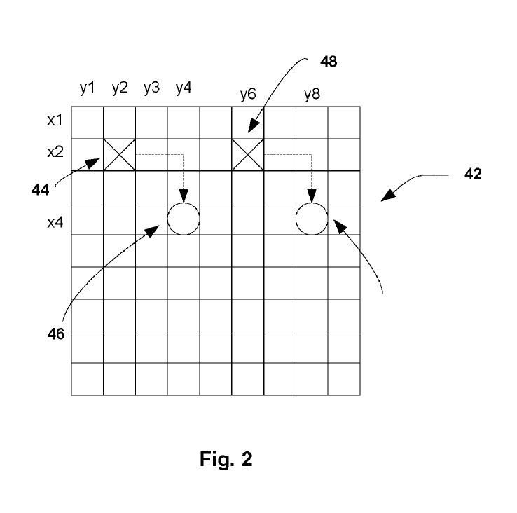

For the sake of convenience, this procedure is described as comprising two logically consecutive parts; however, there is no absolute need for the first part to finish before the second part begins. In other words, the second part can be invoked while the first part is still processing part of the image. In the first part (first sub-procedure), each or at least most of the pixels in the image to be processed are calculated as to their level of divergence, each from a respective reference pixel. To help explain this, reference is made now to FIG. 2. Image 42 is a two dimensional array of pixels. Each pixel has an x coordinate and a y coordinate. The pixel at image 42 located at coordinate x₂y₂ is referred to as pixel 44 and is marked in the figure by an X. Pixel 44 has a reference pixel, marked by circle, at coordinates x₄y₄ designated 46. The divergence level is a measure of the difference in values between pixel 44 and its reference, i.e. pixel 46. In one embodiment this is simply done by subtracting the numerical color value of pixel 46 from the respective value of pixel 44, and taking the absolute value in case the result is negative, thus the difference d for the pixel pair is:

|P₄₄−p₄₆|=d_{44,46} EQUATION 1:

However since the great majority of images dealt with nowadays are in full color, the same calculation is carried out for each color layer of the pixel, and the differences summed. For example, for an RGB color system; respective differences:

for the red layer |Pr₄₄−Pr₄₆|=dr_{44,46}

for the green layer |Pg₄₄−Pr₄₆|=dg_{44,46}

for the blue layer |Pb₄₄−Pb₄₆|=db_{44,46}

and the total difference is calculated by adding up all the three respective color differences, for a specific pixel:

Total difference, td=dr_{44,46}+dg_{44,46}+db_{44,46} EQUATION 2:

The same calculation is to be applied to all of the pixels, possibly with the exception of pixels at the border of the image. Another example, is pixel 48 at coordinates x₂y₆ having a reference pixel at coordinates x₄y₈. The differences in the respective three color layers are calculated with reference to its own reference pixel, i.e. the pixel at coordinates x₄y₈.

It is to be noticed that in the sample sub-procedure the features of which were above, the position of the reference pixel is removed two pixels to the right and two rows below the processed pixel. This conformation is exemplary and many other conformations can be applied, for example, a reference pixel can be an adjacent pixel, above, below or at the sides. However, the example given above takes into consideration that the farther away a pixel is situated, the more the likelihood of substantial differences existing between the two exist.

Additionally, it is proposed that for many scenes, horizontal and or vertical structures are present, typically but not restricted to urban settings. The location of the reference pixel at a diagonal distance from the respective categorized pixels improves the chances that the two pixels will not be located on the image of the same structure. As mentioned above, all the pixels are categorized, but in a typical situation, pixels at the edge of the image may be skipped. It is worthwhile mentioning that each pixel serving as a reference pixel, at its turn, becomes a categorized pixel.

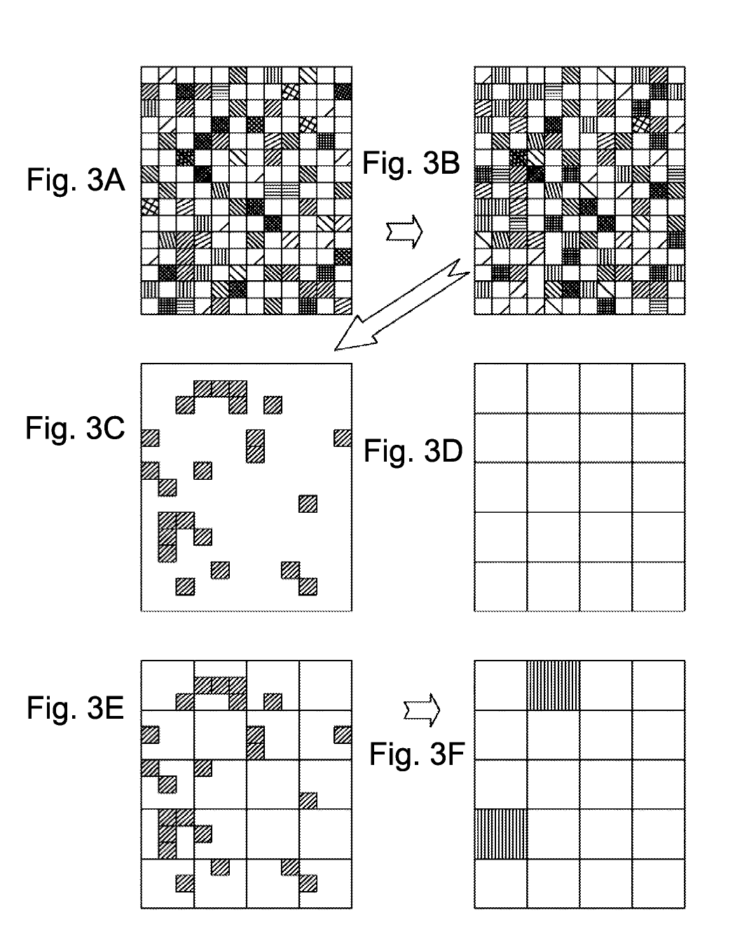

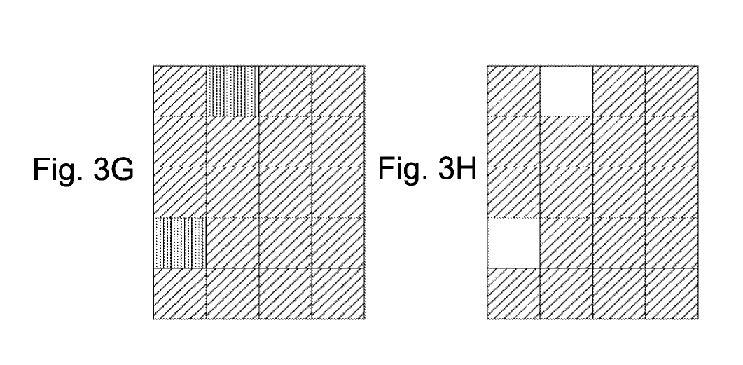

In the second sub-procedure of the pixel divergence categorization procedure a cutoff divergence threshold is applied to each pixel processed in the first sub-procedure. Each of the pixels of the original image will be thereafter categorized as having divergence either above or below a certain threshold value. Reference is made now to FIGS. 3A and 3B. In FIG. 3A, a schematic of a digital image is shown, in which each square element of the crisscross pattern denotes a pixel. A hatching pattern signifies the individual original color information associated with the different pixels, a typical situation existing in multi colored images. In FIG. 3B all the pixels express each the calculated value, resulting from the application of the first sub-procedure. Such an image is therefore synthetic, the pixels of which do not represent directly a natural color or shade.

Finally, a threshold cutoff is applied to each of the synthetic pixels, such that there are only two kinds of pixel categories left, pixels of divergence level either above a threshold (hatched as an example) or below that threshold. All pixels having td values (see equation 2 above) surpassing a specific threshold (empirical or arbitrary) are given a value, say, 1 and the others, not surpassing that threshold are given a value 0. The pixels of a divergence value larger than the threshold will be referred to as positive pixels and the others as blank pixels.

Grid Element Homogeneity Determination and Classification Procedure

To explain the transition from the pixel divergence procedure to the grid element (GE) homogeneity determination procedure, reference is first made to FIG. 3C. In that figure, synthetic image exhibiting two categories of pixels, the hatched pixels the calculated values of which surpassing the threshold, and the non-hatched pixels, the calculated value of which not surpassing the threshold, referred to also as blank pixels. The image in FIG. 3C, is only 1 bit deep, i.e. a logical value of 1 or zero. The pixels in FIG. 3A are 8, 24 bit deep, or any other value available technically

In FIG. 3D a grid structure is shown, expressing the layout of grid elements such that each grid element has a larger size than a pixel. in the case illustrated, each grid element is 3×3 pixels in area and binds therefore 9 pixels within its limits. This size is a convenient practically, but other xy size combinations may be used. In FIG. 3E the grid is shown imposed on the image shown in FIG. 3C. Before continuing with the description of the homogeneity determination procedure, it should be mentioned that the procedure of pixel divergence categorization is complete at least in regions, before the homogeneity determination procedure is implemented. In this example, in FIG. 3E, a certain number of hatched pixels are shown, each representing a positive pixel.

Further in the procedure, each grid element is processed independently, in this example, only grid elements containing a hatched pixels number surpassing 4, are marked, in FIG. 3F, as shown pictorially by grid element vertically hatched in its entirety. This means that in the entire process there are at least two thresholds involved. First a divergence threshold for the individual calculated pixels, and then homogeneity threshold denoting the smallest number of positive pixels found within the limits of a grid element, required to classify the entire grid element as being non homogenous. Loosely stated, the meaning of a grid element as classified by the procedure described above as non-homogeneous is that it contains certain amount of variability, namely it surpasses a minimal level (threshold) of information content in order to qualify for such classification. It logically follows that such classified grid elements should not be used for applying annotations.

In accordance with the present invention, the blank grid elements, i.e. those not containing information (i.e. homogeneous grid elements) are to be selected as candidates for forming the rectangular aggregates in which the user will be advised to put his/her graphic annotations. Therefore as can be seen in FIG. 3G, all the blank grid elements of FIG. 3F are given another, slanted hatch, and in FIG. 3H the grid elements formerly hatched (vertically) (i.e. non homogeneous) are now disregarded as they should not be considered as relevant for the rest of the process. At this stage, all the hatched grid elements are considered as “blank grid element” containing no information, or the amount of contained information is insignificant.

A Procedure for Forming Rectangular Aggregates Composed of Blank Grid Elements

All the available grid elements in the map of classified grid elements are considered by the procedure as potential grid elements, and all the blank grid elements are considered candidates for inclusion in rectangular aggregates. The aim of this procedure is to define blank sectors for use as locations to insert annotations or marks. First, the procedure searches the classified grid elements, by selecting a grid element, typically arbitrarily.

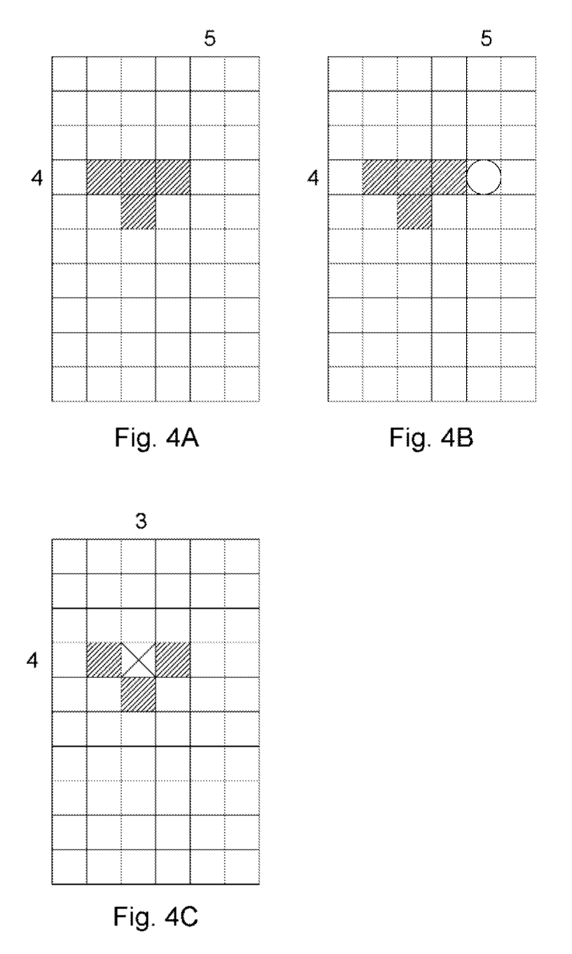

Referring now to FIGS. 4A-C, the procedure is further described. The initial map of grid elements is described in FIG. 4A. It should be noted that the grid coordinates are different than the pixel coordinates dealt with above, but overlay the image pixel coordinates. A grid element is always larger than one pixel, and equals typically a multiple value of whole pixels both in the x and y coordinates. Most of the grid elements in this example are non-blank (designated by white coloring) while some grid elements are blank, designated by slanted hatching. The first grid element to be selected, as seen in FIG. 4B is the grid element positioned at grid element coordinates X₅Y₄, and the selection marked by a circle. It is non-blank, and will therefore be disregarded. The procedure will restart, selecting another grid element. If it is blank, the procedure will continue, if not, it will restart picking another grid element, typically arbitrarily, and so on until a blank grid element is found, and added to a set including a rectangular aggregate of grid elements (SORG) by indexing.

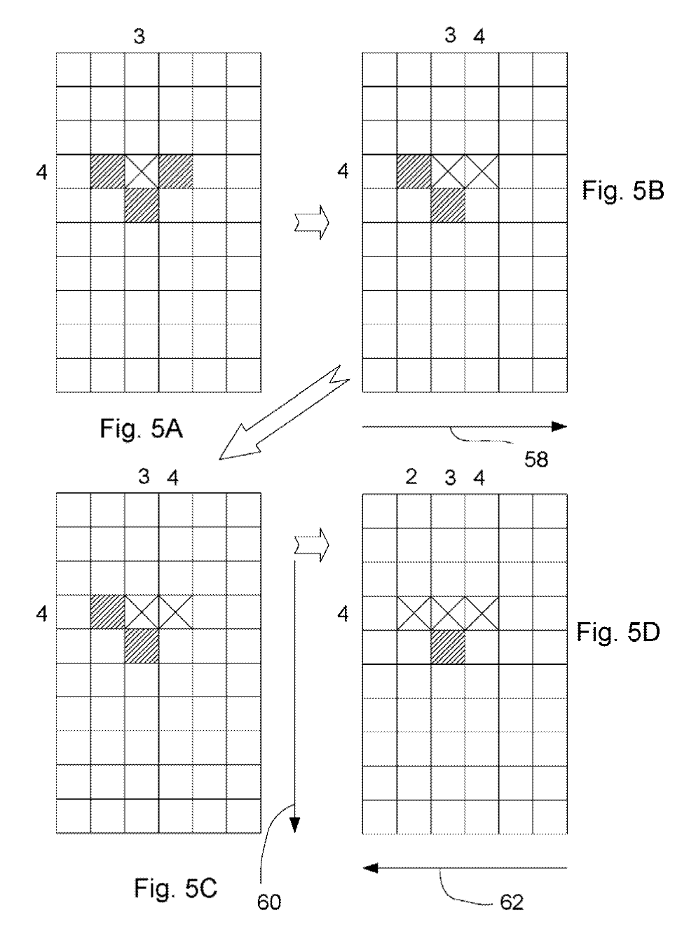

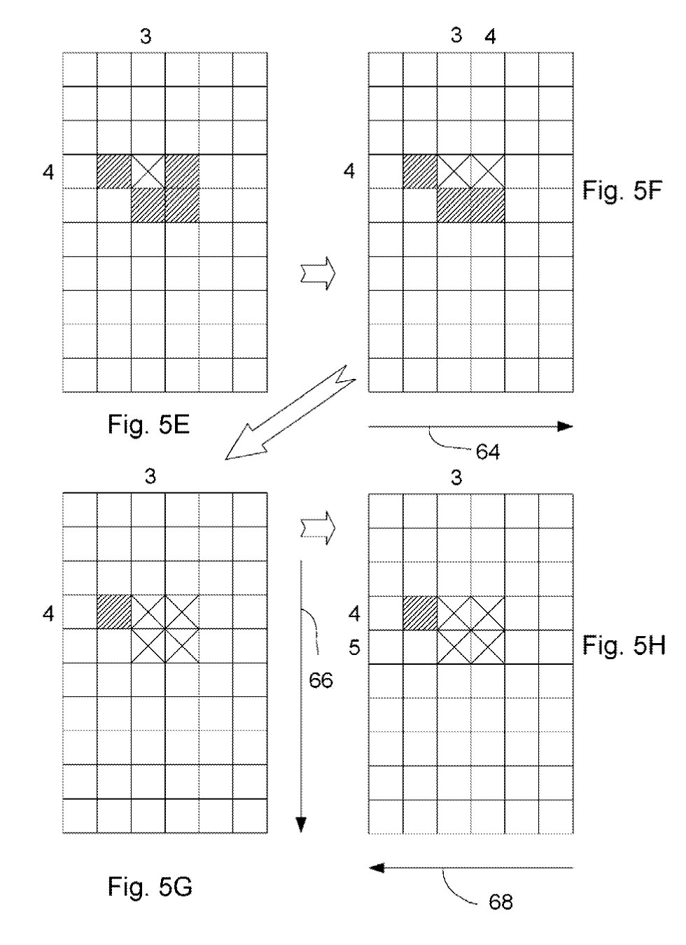

In FIG. 4C, the grid element at grid element coordinates X₃Y₄ was selected, and was the first blank grid element to be found. It is indexed, for the sake convenience, as BGE₁. In FIG. 5A, the first indexed blank grid element is the grid element in grid coordinates X₃Y₄, it is marked by a large X. The procedure then checks for adjacent blank grid elements in an ordered, cyclical sweep, divided into quarters having predetermined direction. For example, the sweep can be defined as: clockwise, right, bottom, left and upward. As can be seen in FIG. 5B, a blank grid element is found adjacent to BGE₁, in the sweeping direction indicated by arrow 58, namely the grid element at coordinates X₄Y₄, it will be indexed as BGE₂, and the SORG includes now both blank grid elements. Once having two or more adjacent blank grid elements, a new condition is implemented by the procedure, the procedure will add in each next quarter sweep new indexed grid elements only if there is a new (non-indexed) blank grid element counterpart available for each one of the already indexed grid elements bordering the potential grid elements, in the direction of sweep.

If there are no new blank grid elements available for each of the already indexed grid elements bordering the potential grid elements in the direction of sweep, the procedure skips a direction in the sweep and goes to the next direction. Thus, in the direction as marked by arrow 60 of FIG. 5C, there was blank grid element available for the indexed grid element at X₃Y₄, but there was no blank grid element available for the indexed grid element at X₄Y₄, and there was no new index provided at this quarter sweep. Next, the sweep continues as indicated by arrow 62 of FIG. 5D, and a new blank grid element was indexed, namely grid element at X₂Y₄, no limit applied because there was just one grid element in the direction of sweep.

In another example, described schematically in FIGS. 5E-5H, a slightly different distribution of blank grid elements is shown. As in the former example, the first indexed grid element is the one at coordinates X₃Y₄ shown in FIG. 5E marked by a large X, in FIG. 5F a sweep in the direction of arrow 64 is conducted, adding another grid element to the set of indexed grid elements, namely the grid element at coordinates X₄Y₄. Then at the next step as seen in FIG. 5G, the procedure sweeps in the direction of arrow 66. Since there are two indexed grid elements now, the new condition is to be applied, meaning there will be no more new grid elements indexed unless for each and every one of the existing indexed grid elements facing the direction of sweep, there will be a respective candidate grid element, which will be then indexed to join the set of indexed grid elements.

Finally, for this example, in FIG. 5H the result of the next sweeping step is shown. This time the sweep was carried out in the direction of arrow 68 and no new indexing was accomplished because there was no candidate grid element available for the indexed grid element at coordinate X₃Y₅. In this example the aggregate has stopped expanding and will be abandoned by the procedure. The procedure will however look for a new, unsearched grid element, and start over again. In the end of this stage, the procedure will have searched all the potential grid elements, and none, one or more rectangular aggregates will be derived therefrom, typically overlaid on the image to indicate optional locations for inserting suitable graphic or alphanumeric items to insert in the image, in the limits of any one of the rectangular aggregates. Changing the two thresholds discussed above is likely to change the size, and number of rectangular aggregates.

Additional Sources of Positive or Blank Pixels

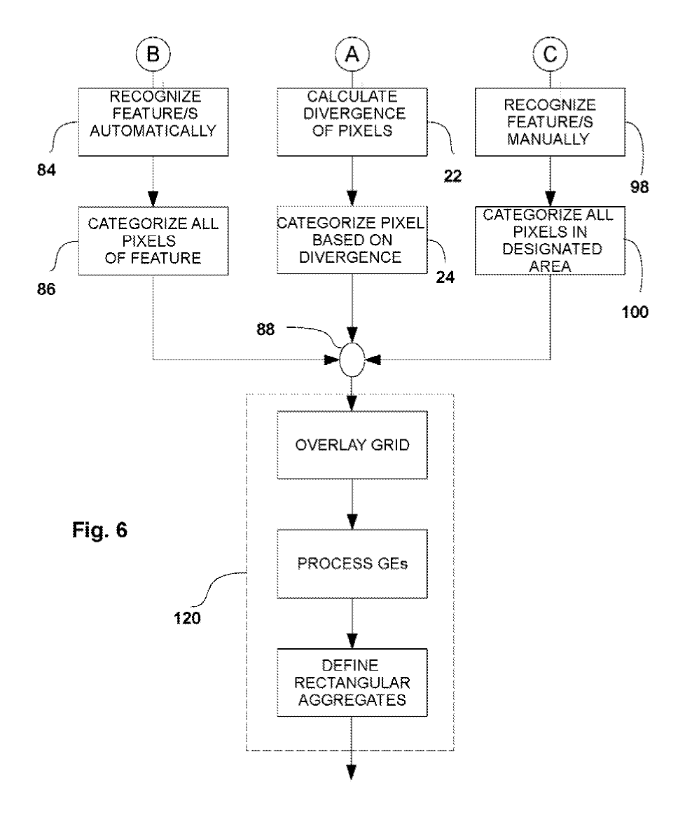

The process for providing blank grid elements described above is one of several alternative tracks according to which blank or non-blank sectors are computed and presented to the user typically on the user's end-point in a network as locations on which he/she may or may not put graphical information. As can be seen in FIG. 6 Track A is the track through which pixels are categorized as described hereinabove, by reference to their divergence. Subsequently grid elements are classified as described hereinabove. Divergence is calculated in step 22 and categorization in step 24. In track B, one or more recognition procedures may be applied to an image received by the user or application program, typically through the network.

There are a multitude of recognition procedures known in the art of image processing. Generally known as image recognition, this discipline is usually subdivided into face recognition, target recognition, optical character recognition which is a very well known application used in the art of image processing, but other less well known procedures are also applicable. In order to explain how such procedures are used in the context of the present invention, reference is made to the next figures as follows. Separately and or alternatively, in track B, features are recognized by a recognizing procedure in step 84, and such pixels that fall under the outlines of a recognized image are categorized, typically as being positive, in step 86, and then pooled in step 88 together with pixels categorized in tracks A and or C, to form the category of either positive or blank pixels.

Alternatively or additionally, in track C, in step 98 features on the image are recognized by the user, manually. The user marks the feature by any one of methods known in the art such as by inserting a graphical overlay, or actually marking specific pixels or groups of contiguous pixels using an input device. Following, in step 100 the manually marked pixels are categorized typically as positive pixels but may be defined as blank pixels. Next, all the pooled pixels can undergo grid element (GE) homogeneity determination procedure and blank sector determination as described above, in procedure 120.

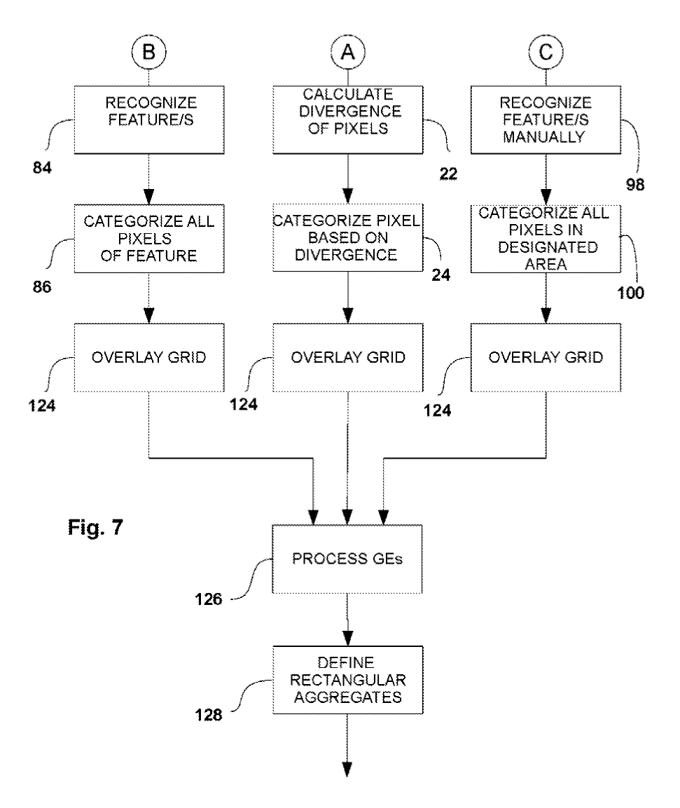

In an alternative overall process, as explained in the flow chart of FIG. 7, Features in the image, such as alphanumeric character, face and other images are recognized in track B. The server application or end point application or user may decide that all images recognized are to remain visible in the final image, and therefore the pixels under the extent of the recognized image are defined as positive. Then, in step 124, a grid is overlaid, but in this track, the procedure may opt to leave any grid element containing such a positive pixel as a non-blank grid element. The procedure may opt to treat it as described for track A grid elements, meaning that a grid element will be determined as being homogeneous or not by the content of categorized pixels in them. As regards track C, manual demarcation of features on the image results in the categorization of all pixels falling under the outlines of the feature as being typically positive.

Thus it remains that the overlaying of grid will require the procedure to decide if a grid having a positive pixel remains homogeneous or else that the grid is processed as described for track A. Another track, namely track D, is a track similar in some respects to track C, but in this case the user manually selects one or more locations on the image intended for blanking, i.e. are going to be blank sectors for overlaying or otherwise inserting annotations. In such a case, all pixels within the limits of the areas defined by the user manually are turned blank, grid overlaid, and grid elements processed as before. An alternative possibility is further described that in track D, no gridding is done and all the blank pixels make up the blank sector/s without going through formation of rectangles.

In general, the inclusion of feature recognition tracks, may cause areas in the image to be exempt from blanking and thus will not be made available to become a part of a blank sector. Alternatively, using track B and C may add pixels that are defined arbitrarily as blank, and thus add to the pool of regularly obtained blank pixels (in track A). Another alternative is that track A is not implemented at all and only tracks B and or C are invoked. Alternatively, a user or the application requires that the recognized images are left visible, and thus the pixels associated with the feature are made arbitrarily positive, and the overlaid grid element might be arbitrarily made to be non-homogeneous even if it has only one pixel of a recognized feature.

Scheduling and Prioritizing Tracks

All of the tracks may be rendered active, or just a subset may be applied, for example A+C. Another issue is prioritizing, i.e. since each pixel may receive a different definition in each track (positive or blank), it is important when applying more than one track to decide which definition prevails. Thus, it can be decided for example that manual selection always overrules automatically produced pixel definitions (of track A). Alternatively, priority may be bestowed by timing order. For example track B first, track D second and priorities in that order.

Applications and Uses of the Invention

In the current stage of technology available to all, digital cameras are the only realistically available type of imagery collection hardware, whether for strictly personal use, or for professional use. Pictures taken either by amateurs, journalists, professional photographers and all other visual data collectors, are all digital. Digital images lend themselves easily to distribution by digital media, such as Internet, 3rd generation cellular or simple disk handling. The method provided by the invention allows the user, whether an automated process or a person, amateur or professional, to add comments to images quickly and conveniently.

Typically, but not exclusively, the rectangular aggregates are applied as a graphic overlay on the image, such that the image pixels are not lost. The rectangular aggregates may be presented to the end user in graphic overlay over the image such that only the borders are marked or the rectangles are colored or hatched to enhance conspicuity. A color coding may be applied, so that for larger rectangles a deeper color can be assigned to assist the human user to select larger rectangles.

Nevertheless the user may be an automated application, performed as a server application attached to a network and color or visual coding may not be necessary. If the insertion of comments on images is provided by an automated service implemented by a server on the Internet, an end user may send images to that server for attaching comments or for preparing the images for self application of comments. In addition an application using the method of the present invention may be implemented automatically while receiving images on an automated basis, for example, archiving service. An archiving service may opt between applying the method of the invention or sending the images with instructions as to what annotations comments to overlay.

In another aspect, users may be provided with a bank of pre-existing images, words or any graphic material that can be attached to an image as the rectangular aggregate is indicated over an image. The user may be required to trim, stretch or compress a pre-existing image in order to place it in a rectangle. Further, for an existing annotated image in accordance with the present invention, changing the annotation is also a viable possibility.

What is claimed is:

1. A process for providing producing rectangular aggregates in a digital image, for the purpose of inserting an annotation in said image, said process comprising:
selecting a digital image;
implementing a divergence level calculation procedure, in which substantially all the pixels of said image are categorized either above or below a divergence threshold, and the pixels surpassing said threshold are referred to as positive pixels;
imposing a grid of grid elements on said image, wherein each of said grid elements is larger than a pixel;
implementing a grid element homogeneity calculation procedure for each one of said grid elements separately, by employing a homogeneity threshold for classifying said grid elements as either homogeneous or non-homogeneous;
implementing a rectangular aggregate formation procedure, in which homogeneous grid elements are indexed in sets; and
indicating rectangular aggregates derived from said rectangular aggregate formation procedure, on said digital image.

2. The process as in claim 1 wherein said divergence level is measured between pixels of the image and respective reference pixel positioned at a diagonal distance with respect to said pixels surpassing said divergence threshold and referred to as positive pixels.

3. The process as in claim 1 wherein said threshold for calculating said grid element homogeneity takes into consideration the number of positive pixels bound within the limits of a respectively imposed grid element.

4. A process as in claim 1 wherein said rectangular aggregate formation procedure starts off by finding a non-homogenous grid element, further indexing it, then finding at least one contiguous non-homogenous grid element on any of the four adjacent quarters of a cyclical sweep, further indexing at least said one of four grid elements, and if more than one grid element is indexed, new grid elements are to be indexed only if by continuing to sweep all the indexed grid element in the direction of sweep, finding counterpart contiguous homogeneous grid elements.

5. The process for providing aggregates in a digital image, for the purpose of inserting an annotation in said image, said process comprising:
selecting a digital image;
implementing a recognition procedure on said image;
defining the outlines of at least one object recognized, and
categorizing the pixels falling under said outlines.

6. The process as in claim 5, wherein said categorizing includes pooling pixels together with pixels categorized for divergence in the pixel divergence and categorization procedure, before applying a homogeneity determination procedure and blank sector determination.
